(19) United States
(12) Patent Application Publication
(10) Pub. No.: US 2014/0172489 A1
(43) Pub. Date: Jun. 19, 2014

(54) TECHNIQUES FOR USING A HEAT MAP OF A RETAIL LOCATION TO DISPERSE CROWDS

(71) Applicant: Valerie Goulart, Seattle, WA (US)

(72) Inventor: Valerie Goulart, Seattle, WA (US)

(73) Assignee: Wal-Mart Stores, Inc., Bentonville, AR (US)

(21) Appl. No.: 13/715,635

(22) Filed: Dec. 14, 2012

(51) Int. Cl. G06Q 10/06

(52) U.S. Cl. CPC G06Q 10/06312
USPC 705/7.22

(57) ABSTRACT

A computer-implemented method is disclosed herein. The computer-implemented method includes the step of monitoring, at a processing device, regions of a retail location. The computer-implemented method also includes the step of determining, at the processing device, a crowd size for each region based on the monitoring step and indicative of an amount of people in the region when the monitoring step is executed. The computer-implemented method also includes the step of generating, at the processing device, a heat map based on the crowd sizes in each region, the heat map being indicative of the amount of people in each of the regions. The computer-implemented method also includes the step of promoting a reduction in the crowd size in at least one of the regions.

### BACKGROUND INFORMATION

1. Field of the Disclosure

The present invention relates generally to systems and methods for using a heat map of a retail location to reduce crowd sizes in the retail location.

2. Background

Many consumers visit supermarkets and superstores when shopping for products such as groceries, office supplies, and household wares. Typically, these stores can have dozens of aisles and/or sections. Accordingly, traversing these aisles looking for specific products may be a harrowing experience. Furthermore, certain regions of the store will randomly encounter crowding. For example, the deli counter may have no customers waiting for service, and in just a few minutes, the deli counter may have many customers in line. Similarly, a retail location may have 20 or more checkout stations. Some checkout stations may have long lines, while some checkout stations may have no lines, unbeknownst to those waiting in the longer lines. Long lines and large crowds at a retail location can be frustrating to customers and tend to discourage customers from shopping at the retail location.

### BRIEF DESCRIPTION OF THE DRAWINGS

Non-limiting and non-exhaustive embodiments of the present disclosure are described with reference to the following figures, wherein like reference numerals refer to like parts throughout the various views unless otherwise specified.

FIG. 1 is a schematic illustrating a heat map server in communication with a monitoring system that monitors a retail location according to some embodiments of the present disclosure;

FIG. 2 is a schematic illustrating example components of the heat map server of FIG. 1;

FIG. 3 is a schematic illustrating an example of a heat map according to some embodiments of the present disclosure;

FIG. 4 is a flow chart illustrating a first exemplary method for reducing crowd size using a heat map according to some embodiments of the present disclosure;

FIG. 5 is a schematic illustrating an example of a heat map according to some embodiments of the present disclosure;

FIG. 6 is a flow chart illustrating a second exemplary method for reducing crowd size using a heat map according to some embodiments of the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present disclosure. It will be apparent, however, to one having ordinary skill in the art that the specific detail need not be employed to practice the present disclosure. In other instances, well-known materials or methods have not been described in detail in order to avoid obscuring the present disclosure.

Reference throughout this specification to “one embodiment”, “an embodiment”, “one example” or “an example” means that a particular feature, structure or characteristic described in connection with the embodiment or example is included in at least one embodiment of the present disclosure. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams in the flow diagrams illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

In order to allow the managers of retail stores to better distribute customer traffic, systems and methods are disclosed for using a heat map to dissipate crowds in a retail location, where the heap map is indicative of the crowd sizes in each region of the retail location. As used herein, the term “heat map” can include any representation of a retail location that can convey crowd sizes corresponding to one or more regions of the retail location. The term “retail location” can include brick-and-mortar stores operated by a single retailer, e.g., supermarket or superstore, or a location that includes stores operated by multiple retailers, e.g., a shopping mall or a shopping plaza.

A heat map can be utilized to perform various tasks. For instance, the heat map may be used to determine a region of the retail store that has historically been a location at which undesirably large crowds have formed. The point of over-crowding can be dependent on the region in the retail location or can be selected independent of region. For example, a grouping of ten customers or more can define over-crowding in any region of the store. In some embodiments, the heat map can be used to monitor the floor of the retail store in real time. In this way, the areas in which large crowds of customers accumulate can be identified and proactively addressed.

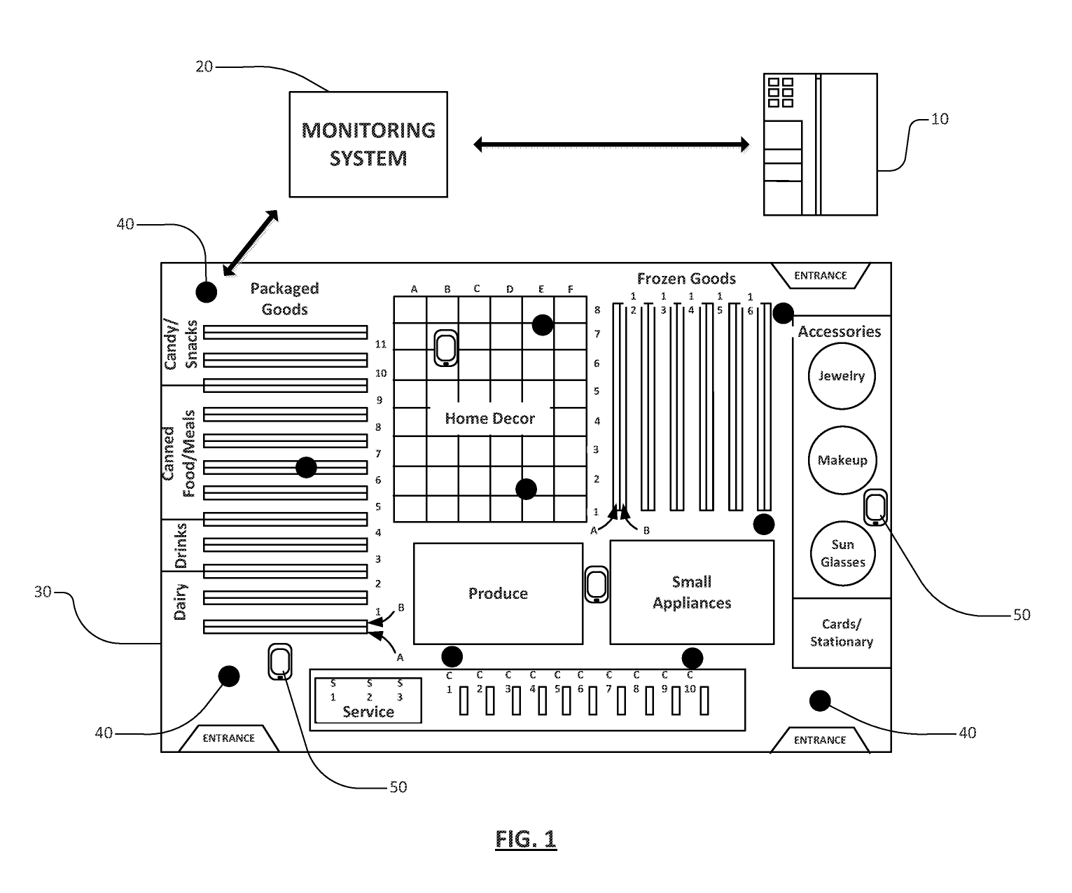

Referring now to FIG. 1, an example of a system for generating a heat map is disclosed. In some embodiments, the system includes a heat map server 10 and a monitoring system 20 that monitors a retail location 30. As used herein, the term “monitoring system” can include any combination of devices that monitor different regions of the retail location 30 to determine crowd sizes (or approximate crowd sizes) in each of the regions. The monitoring system 20 can provide raw data that is indicative of the crowd sizes in each region of retail location to the heat map server 10 and/or can process the raw data to determine the crowd sizes in each region and provide the crowd size to the heat map server 10. For purposes of explanation, the monitoring system is described as being configured to process the raw data to determine the crowd sizes in each region.

The exemplary retail store 30 illustrated in FIG. 1 can be arranged into different departments, such as packaged foods including dairy, drinks, canned foods/meals, and candy/snacksproduce; home decor; produce; frozen goods; small appliances; and accessories including jewelry, make-up, sunglasses, and cards/stationary. Each department can be further delineated. For example, the exemplary packaged goods area of the retail store 30 is subdivided into aisles 1-11 and each aisle can define an “a” side and a “b” side opposite the “a” side. The exemplary home decor area can be divided into a grid by letters A-F along a first edge and numbers 1-8 along a second edge perpendicular to the first edge. The illustrated, exemplary retail store 30 can also include one or more entrances, a service counter, and several checkout lines each referenced in FIG. 1 by the letter “c” and a number. It is noted that the arrangement of the retail store 30 is exemplary. In some embodiments of the present disclosure a retail store 30 can be arranged differently and include different departments and/or different products.

In some embodiments, the monitoring system 20 includes a plurality of sensors 40 dispersed throughout the retail location 30. It is noted that in FIG. 1 less than all of the sensors 40 are annotated to enhance the clarity of the figure but are illustrated identically. The plurality of sensors 40 can include video cameras and/or motion sensors. In some embodiments, the video cameras used for generating heat maps can also be the video cameras used for security monitoring. In these embodiments, the monitoring system 20 receives input from one or more sensors 40 in a particular region. For example, the input received by the monitoring system 20 can be a video feed from a video camera monitoring a particular region or a section of the particular region. It is noted that in FIG. 1 only one of the sensors 40 is shown communicating with monitoring system 20 to enhance the clarity of the figure, but all of the sensors 40 can communicate with the monitoring system 20 in some embodiments of the present disclosure. In some embodiments, the monitoring system 20 analyzes the input from the sensors 40 to determine the crowd sizes in each region of the store. As used herein, the term “crowd size” can be indicative of an amount or approximate amount of people in the region. The amount or approximate amount can be a number of people in the region, a population density, e.g., people per square foot, and/or a relative amount, e.g., heavily crowded or lightly crowded. In embodiments where the crowd size indicates a population density, the monitoring system 20 can approximate the amount of people in the region and divide the amount of people by the square footage of the region.

In some embodiments, the monitoring system 20 implements crowd sourcing techniques to determine the crowd sizes in each of regions in the retail location 30. In these embodiments, the monitoring system 20 can receive real-time locating system coordinates from mobile computing devices 50, e.g., smart phones, of customers located within the retail location 30. For example, the retail location 30 may furnish a wireless network that allows the mobile computing devices 50. While a mobile computing device 50 is connected to the wireless network, the monitoring system 20 can request the location of mobile computing device 50 and the mobile computing device 50 can provide its location. Alternatively, the mobile computing device 50 can be configured to automatically report its location while traveling through the retail location 30. The monitoring system 20 receives the locations of each mobile computing device 50 in the retail location and, for each mobile computing device 50, determines a region of the mobile computing device 50. In this way, the monitoring system 20 can determine many mobile computing devices 50 are each region of the retail location 30 based on the reported locations, which is utilized to determine the crowd size in each region. Furthermore, the monitoring system 20 may be configured to extrapolate the crowd size of a particular region based on the amount of mobile computing devices 50 in the region. For example, if statistical data shows that one in four customers have mobile computing devices 50 that report their location, the monitoring system 20 may multiply the number of mobile computing devices 50 in a particular region by four to estimate the crowd size of the region. It should be appreciated that the monitoring system 20 may be configured to estimate the crowd sizes in any other suitable manner. It is noted that in FIG. 1 less than all of the mobile computing devices 50 are annotated to enhance the clarity of the figure but are illustrated identically.

While shown as being separate from the heat map server 10, in some embodiments, the monitoring system 20 can be implemented as part of the heat map server 10. In these embodiments, the heat map server 10 receives the input from the sensors 40 and/or the mobile computing devices 50.

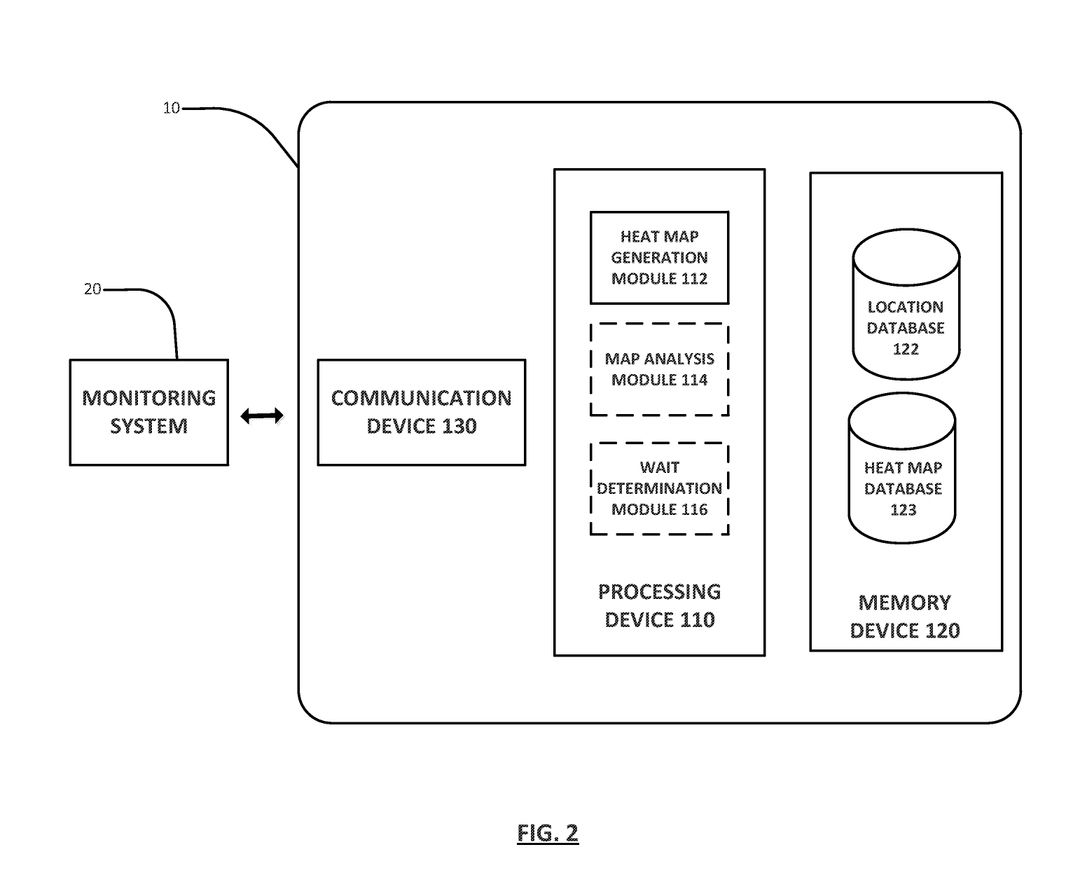

The heat map server 10 obtains the crowd sizes in each region of the retail location and generates a heat map based thereon. Referring now to FIG. 2, an example of the heat map server 10 is illustrated. In the illustrated example, the heat map server 10 includes, but is not limited to, a processing device 110, a memory device 120, and a communication device 130.

The communication device 130 is a device that allows the heat map server 10 to communicate with another device, e.g., the monitoring system 20, the sensors 40, and/or the mobile computing devices 50, via a communication network. The communication device 130 can include one or more wireless transceivers for performing wireless communication and/or one or more communication ports for performing wired communication.

The processing device 110 can include memory, e.g., read only memory (ROM) and random access memory (RAM), storing processor-executable instructions and one or more processors that execute the processor-executable instructions. In embodiments where the processing device 110 includes two or more processors, the processors can operate in a parallel or distributed manner. In the illustrative embodiment, the processing device 110 executes one or more of a heat map generation module 112, a map analysis module 114, and a wait determination module 116. Furthermore, in some embodiments, the processing device 110 can also execute the monitoring system 20 (FIG. 1) or components thereof.

The memory device 120 can be any device that stores data generated or received by the heat map server 10. The memory device 120 can include, but is not limited to a hard disc drive, an optical disc drive, and/or a flash memory drive. Further, the memory device 120 may be distributed and located at multiple locations. The memory device 120 is accessible to the processing device 110. In some embodiments, the memory device 120 stores a location database 122 and a heat map database 123.

The location database 122 stores maps corresponding to different retail locations. Each map can be divided into a plurality of regions. A region can describe any type of boundary in the retail location. For instance, in the supermarket setting, a region can refer to a section, e.g., deli or frozen foods, one or more aisles, e.g., aisle 10, a checkout station, and/or a bank of checkout stations. In some embodiments, the regions may be defined by a collection of real-time locating system coordinates. Additionally, each map may have metadata associated therewith. The metadata for a map can include crowd size thresholds, which are described in further detail below. Furthermore, for each retail location, the location database 122 may store product locations for the items sold at the retail location. Each item can have a real-time locating system location or a relative location, e.g., GOLDEN GRAMS are located at aisle nine, 50 feet from the front of the aisle.

The heat map database 123 can store a plurality of heat maps of the retail location that are generated over time. A series of heat maps of the retail location can be stored in the heat map database 123. Each of the heat maps can be generated at different times. Each of the heat maps can be correlated to the time of the day that the heat map was generated. Each heat map can be correlated to other data as well, such the day of the week, the weather, the month, and the location of the store. Heat maps from more than one store can be compared to one another to identify trends in crowd formation.

The heat map generation module 112 receives crowd sizes pertaining to the regions of a particular retail location and generates a heat map based thereon. The heat map generation module 112 can generate heat maps for each map stored in the location database 122 or can generate a heat map upon receiving a request for a heat map for a particular location from a requesting device, e.g., a mobile computing device, or a requesting process. For purposes of explanation, the description of the heat map generation module 112 assumes that the heat maps are generated in response to a request for a heat map for a particular location. It should be appreciated that the techniques described herein can be modified to generate heat maps for all of the retail locations in the locations database 112 at defined intervals, e.g., every 15 minutes.

The heat map generation module 112 can receive a request to generate a heat map for a particular retail location. In response to the request, the heat map generation module 112 retrieves a map corresponding to the particular retail location from the location database 122. Furthermore, the heat map generation module 112 can receive the crowd sizes for each region of the retail location from the monitoring system 20. For example, the heat map generation module 112 can receive inputs indicating (L, R, CS, T) from the monitoring system, where L is the retail location, R is a region of the retail location, CS is the crowd size in the region R, and T is the time at which the crowd size was determined. The heat map generation module 112 receives these inputs for each of the regions in the particular retail location.

Based on the received input, the heat map generation module 112 can annotate the retrieved map to indicate the crowd sizes in each region. In some embodiments, the heat map generation module 112 can determine a relative crowdedness for each region, e.g., empty, lightly crowded, moderately crowded, and heavily crowded, and congested. The heat map generation module 112 can determine the relative crowdedness of each region by comparing the crowd size of the region with one or more crowd size thresholds. In some embodiments, the crowd size thresholds for each region can be stored in the location database 122 in the metadata of the map of the retail location. Each crowd size threshold can correspond to a different relative crowdedness. For example, 0 people in the region can be classified as empty, less than 3 people in the region can be classified as lightly crowded, more than 3 and less than 10 people can be classified as moderately crowded, and more than 10 people in the region can be classified as heavily crowded. It should be appreciated that the crowd size thresholds can be set based on various considerations. For example, regions that tend to take longer to service a customer, e.g., deli counter or meat counter, may have lower thresholds than regions that do not require much time to service a customer, e.g., the produce region. Similarly, areas that are narrower, e.g., aisles, may have lower thresholds than areas that are more wide open, e.g., produce region.

Once the heat map generation module 112 has determined the relative crowdedness of each region of the retail location, the heat map generation module 112 can annotate the map of the retail location to indicate the relative crowdedness in each of the locations. In some embodiments, the heap map generation module 112 can use a color scheme to indicate the relative crowdedness, e.g., no color=empty, green=lightly crowded, yellow=moderately crowded, and red=heavily crowded. In some embodiments, the heat map generation module 112 can annotate the map using symbols, patterns, or words to indicate the relative crowdedness of each region.

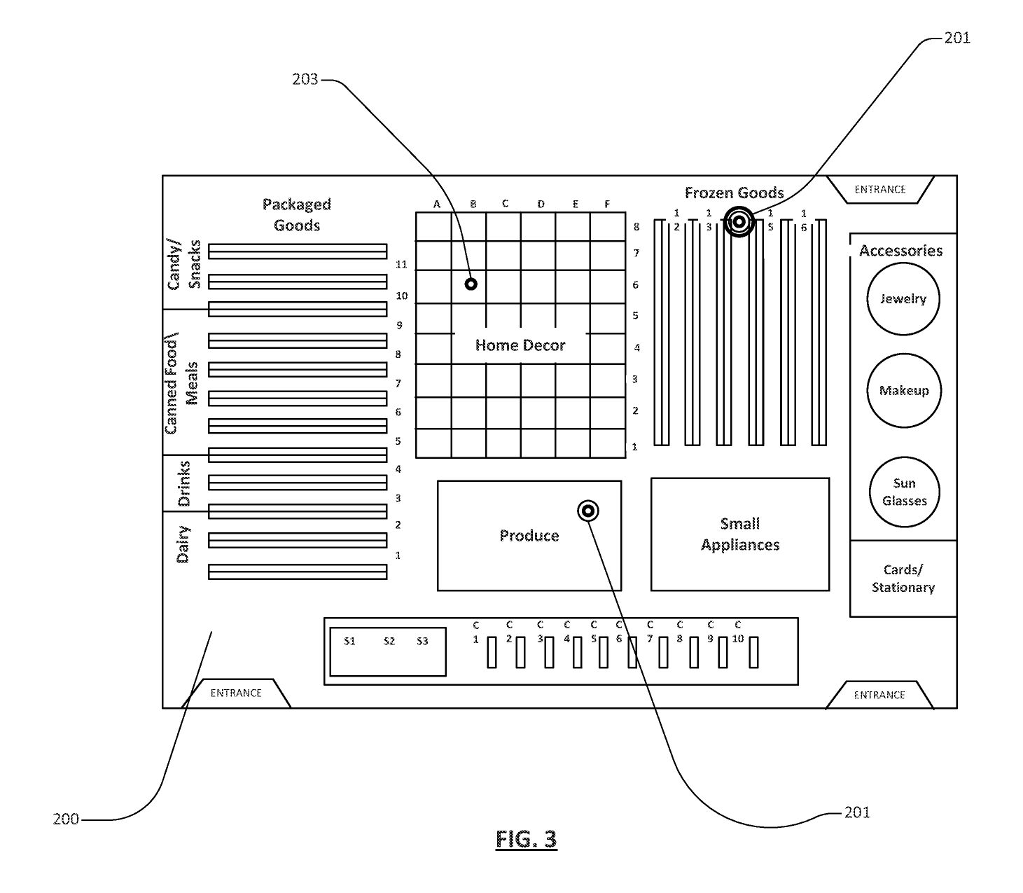

For example, FIG. 3 illustrates an example of a heat map 200. In the illustrated example, the heat map 200 is a map of a retail location that has been annotated with words that indicate the relative crowdedness of the different regions of the retail location. For example, the “frozen goods” region is heavily crowded as indicated by visual indicia 201, the “candy and snacks” region has no crowd, and the “produce” region is moderately crowded as indicated by visual indicia 202, and the “home décor” region is lightly crowded as indicated by visual indicia 203. The visual indicia 201, 202, 203 can be colored differently from the remainder of the heat map 200 or can be flashing in order to be more easily located. While the example illustrates the heat map being annotated using words, it should be appreciated that the heat map can be annotated in any suitable manner, including but not limited to, annotated with colors, symbols, and/or patterns.

Referring back to FIG. 2, a map analysis module 114 is configured to identify a region of the retail location 30 at which the crowd size is a predetermined value or greater. For example, the map analysis module 114 can analyze the heat map generated by the heat map generation module 112. The map analysis module 114 can determine the crowd size at any region of the store based on the heat map. If the crowd size at a region is larger than a predetermined value, the map analysis module 114 can emit an over-crowding alert associated with that region to store management or to employees of the store. In response to the over-crowding alert, actions can be taken to promote dispersion of the crowd at the crowded region. For example, product promotions can be communicated to customers in an attempt to encourage customers to leave the crowded region for a less crowded region.

The wait determination module 116 determines estimated wait times at specific regions in the retail location based on the crowd size at the specific region. The wait determination module 116 can receive the crowd size from the monitoring system 20. Further, the wait determination module 116 obtains a wait function from the location database 122. A wait function can be stored in the metadata corresponding to the retail location for which the wait time is being estimated. The wait function can be any function that is used to estimate the wait time. For example, if at the deli counter the average customer takes three minutes to help, but on average four customers are helped for every seven customers in the deli counter region, the wait function for the deli counter can be Wait Time=( 4/7)*Crowd Size*3. It should be appreciated that the wait time functions can vary from region to region and from retail location to retail location. Once the wait time for a region is determined, the wait time can be annotated onto the heat map. In this way, the heat map can show how long a customer can expect to wait at a given department or at a checkout station. The map analysis module 114 can apply the wait time determined by the wait determination module 116 in the analysis of the heat map.

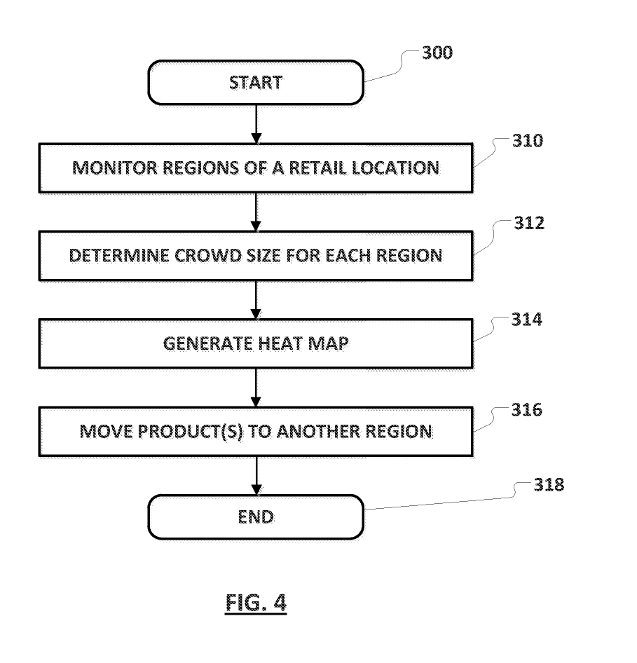

FIG. 4 is a flow chart illustrating an exemplary method that can be carried out in some embodiments of the present disclosure. The process starts at step 300. At step 302, regions of a retail location are monitored. The monitoring can be executed by the monitoring system 20. The retail location 30 can be monitored in real time. The retail location 30 can also be monitored at predetermined time increments. For example, a plurality of heat maps of the retail location can be generated and compared with one another to identify locations at which excessive crowds have tended to form.

At step 312, a crowd size for each region can be determined based on the monitoring step 310. The crowd size is indicative of an amount of people in the region when said monitoring step 310 is executed. The crowd size can be a numeric value or a range. For example, the crowd size can be determined to likely be seven people or can be determined to likely be over five people.

At step 314, a heat map can be generated based on the crowd sizes in each region. The heat map is a visual or graphic representation that is indicative of the amount of people in each of the regions. As set forth above, FIG. 3 is an exemplary heat map. The heap map generation module 112 can use different colors to represent different levels of crowding. For example, an absence of color can represent empty regions of the retail location or regions in which the number of people is not viewed as problematic. In some embodiments, the heat map generation module 112 can annotate the map using symbols, patterns, or words to indicate the relative crowdedness of each region. In some embodiments, the heat map generation module 112 can generate the heat map to display specific numbers, such as the estimated number of people in each region. In some embodiments, the step of generating the heat map can include continuously updating the heat map.

Embodiments of the present disclosure can promote a reduction in the crowd size in at least one of the regions. In some embodiments, the reduction in the crowd size in a first region can be promoted by operation 316 in which the positions of products within the retail store are changed. Operation 316 is optional to some embodiments of the disclosure.

A plurality of heat maps generated over time can be analyzed to reveal that crowds of an undesirable size tend to accumulate in a particular region of the retail location. The undesirable size can be defined by a predetermined value, such as ten people or more than three people. The extent of crowding that is undesirable can be dependent on the region of the retail location. If large crowds are revealed in a particular region of the retail location, in a plurality of the heat maps contained in the heat map database 123, one or more of the products in that region can be moved. In operation 316, products in the region of the retail location at which crowd size is a predetermined value or greater can be moved to another region of the retail location. For example, a particular product or a grouping of products may be the cause of the over-crowding. Moving a product category or a brand of product to a different region of the retail store can cause at least some customers to take different routes to the product and promote the reduction in crowd size. The exemplary process ends at step 318.

The time that a customer generally spends evaluating a product can be a factor in evaluating heat maps and arranging products in the retail location. For instance, in a health section of a retail location, customers tend to take a longer time to decide which product to purchase. For example, a customer generally takes longer to decide which cough syrup to purchase than which brand of bandage to purchase. The products in the retail location can be arranged with respect to one another in order to deter crowd formation. Products that are generally chosen quickly can be positioned across an aisle from products that are considered more carefully to reduce the likelihood of crowd formation. Products that require a greater amount of investigation can be at least staggered within an aisle among products that tend to be impulse purchases and not be directly next to each other or across from each other.

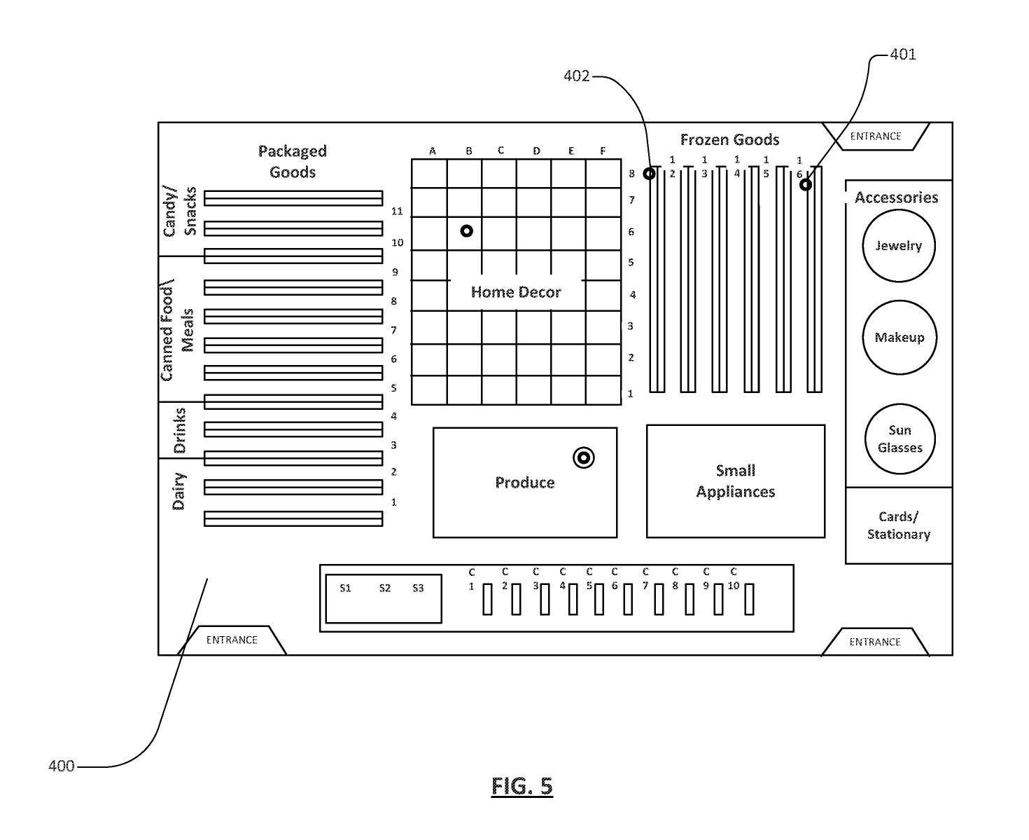

FIG. 5 illustrates an example of a heat map 400. The heat map 400 is analogous to the heat map 200 in FIG. 3. The heat map 400 can result when the exemplary process shown in FIG. 4 is applied to the heat map 200 of FIG. 3. For example, the crowd in the heavily crowded region of the frozen goods section of the retail store, indicated by visual indicia 201 in FIG. 3, has been dissipated. Products that were previously at the end of aisle 14 in FIG. 3 were separated and moved to aisles 12 and 16. These regions are now lightly crowded indicated by visual indicia 401 and 402 in FIG. 5.

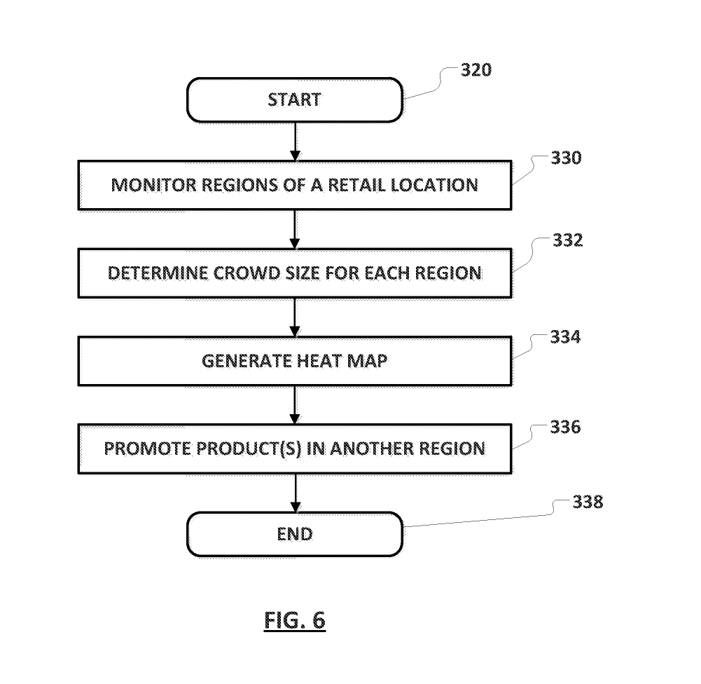

FIG. 6 is a flow chart illustrating an exemplary method that can be carried out in some embodiments of the present disclosure. The process starts at step 320. At step 330, regions of a retail location are monitored. At step 332, a crowd size for each region can be determined based on the monitoring step 330. At step 334, a heat map can be generated based on the crowd sizes in each region.

Embodiments of the present disclosure can promote a reduction in the crowd size in at least one of the regions. In some embodiments, the reduction in the crowd size in a first region can be promoted by operation 336 in which product promotions are communicated to customers in the retail location. The product promotions are for products in a second region, different than the first region. Operation 336 is optional to some embodiments of the disclosure.

Product promotions can be communicated to customers in order to incentivize the movement of customers from a over-crowded region. In some embodiments, a product can be publicized over a public address system. For example, the price of a product in another, less crowded region can be reduced to encourage customers to move from a crowded region. Further, the product promotion can be offered for a predetermined period of time to further promote movement. For example, the price reduction can be communicated as being time-dependent, such as for ten minutes only. Such a product promotion can induce at least some customers to move quickly out of the over-crowded region. The exemplary process ends at step 338.

The above description of illustrated examples of the present disclosure, including what is described in the Abstract, are not intended to be exhaustive or to be limitation to the precise forms disclosed. While specific embodiments of, and examples for, the present disclosure are described herein for illustrative purposes, various equivalent modifications are possible without departing from the broader spirit and scope of the present disclosure. Indeed, it is appreciated that the specific example voltages, currents, frequencies, power range values, times, etc., are provided for explanation purposes and that other values may also be employed in other embodiments and examples in accordance with the teachings of the present disclosure.

1. A computer-implemented method comprising:
monitoring, at a processing device, regions of a retail location;
determining, at the processing device, a crowd size for each region based on said monitoring step and indicative of an amount of people in the region when said monitoring step is executed;
generating, at the processing device, a heat map based on the crowd sizes in each region, the heat map being indicative of the amount of people in each of the regions, a color scheme of the heat map indicating a relative crowdedness of the crowd sizes; and
promoting a reduction in the crowd size in at least one of the regions.

2. The computer-implemented method of claim 1, wherein said promoting step further comprises:
storing a plurality of heat maps of the retail location generated over time.

3. The computer-implemented method of claim 2, wherein said promoting step further comprises:
identifying, with the processing device, a region of the retail location at which the crowd size is a predetermined value or greater in at least some of the plurality of heat maps.

4. The computer-implemented method of claim 3, wherein said promoting step further comprises:
moving products in the region of the retail location at which crowd size is a predetermined value or greater to another region of the retail location.

5. The computer-implemented method of claim 3, wherein said promoting step further comprises:
moving less than all of a plurality of products in the region of the retail location at which crowd size is a predetermined value or greater to another region of the retail location.

6. The computer-implemented method of claim 3, wherein said promoting step further comprises:
moving all brands of one category of products in the region of the retail location at which crowd size is a predetermined value or greater to another region of the retail location.

7. The computer-implemented method of claim 1, wherein said monitoring step further comprises:
monitoring, at a processing device, regions of a retail location in real time through the heat map.

8. The computer-implemented method of claim 7, wherein said promoting step further comprises:
identifying, with the processing device, a region of the retail location at which the crowd size is a predetermined value or greater.

9. The computer-implemented method of claim 8, wherein said promoting step further comprises:
publicizing a product located in a region of the retail location other than the region of the retail location at which the crowd size is a predetermined value or greater in response to said identifying step.

10. The computer-implemented method of claim 9, wherein said publicizing step further comprises:
reducing a price of the publicized product.

11. The computer-implemented method of claim 10, wherein said publicizing step further comprises:
communicating that the price of the publicized product is reduced for a predetermined period of time.

12. A system comprising:
memory storing processor-executable instructions;
one or more processors that execute the processor-executable instructions;
a monitoring system that monitors a plurality of regions of a retail location and determines a plurality of crowd sizes, each crowd size of the plurality of crowd sizes corresponding to one of the plurality of regions, each crowd size being indicative of an amount of people in its corresponding region at a given time;
a heat map generation module that generates a heat map based on the plurality of crowd sizes, the heat map being indicative of the amount of people in each of the regions, a color scheme of the heat map indicating a relative crowdedness of the crowd sizes; and
a heat map database that stores a plurality of heat maps of the retail location generated over time.

13. The system of claim 12, further comprising:
a sensor system interspersed throughout the retail location.

14. The system of claim 12, further comprising:
a map analysis module configured to identify a region of the retail location at which the crowd size is a predetermined value or greater.

15. The system of claim 12, further comprising:
a wait determination module operable to determine estimated wait times at specific regions in the retail location based on the respective crowd size at the specific region.

16. A computer-implemented method comprising:
monitoring, at a processing device, regions of a retail location;
determining, at the processing device, a crowd size for each region based on said monitoring step and indicative of an amount of people in the region when said monitoring step is executed;
generating, at the processing device, a heat map based on the crowd sizes in each region, the heat map being indicative of the amount of people in each of the regions, a color scheme of the heat map indicating a relative crowdedness of the crowd sizes; and
promoting a reduction in the crowd size in a first region by one of changing positions of products within the retail location and communicating promotions for products in a second region different than the first region.

17. The computer-implemented method of claim 16, wherein said promoting step further comprises:
storing a series of heat maps of the retail location wherein each of the heat maps is generated at a different time.

18. The computer-implemented method of claim 16, wherein said promoting step further comprises:
determining if the crowd size of any of the regions of the retail location is greater than a predetermined value.

19. The computer-implemented method of claim 18, wherein said promoting step further comprises:
communicating a time-dependent promotion of products in response to said determining step.

20. The computer-implemented method of claim 16, wherein:
said monitoring step further comprises monitoring, at a processing device, the retail location in real time through the heat map; and
said generating step further comprises continuously updating the heat map.
